(19) United States
(12) Patent Application Publication
(10) Pub. No.: US 2008/0250452 A1
(43) Pub. Date: Oct. 9, 2008

(54) Content-Related Information Acquisition Device, Content-Related Information Acquisition Method, and Content-Related Information Acquisition Program

(76) Inventor: Kota Iwamoto, Tokyo (JP)

Correspondence Address: SCULLY SCOTT MURPHY & PRESSER, PC, 400 GARDEN CITY PLAZA, SUITE 300, GARDEN CITY, NY, 11530, US

(21) Appl. No.: 11/660,611

(22) PCT Filed: Aug. 17, 2005
(86) PCT No.: PCT/JP2005/014979

§ 371 Date: May 8, 2007

(30) Foreign Application Priority Data
Aug. 19, 2004 (JP) 2004-240010

(51) Int. Cl. G06F 3/00

(52) U.S. Cl. 725/39

(57) ABSTRACT

Information relating to content such as a broadcast program is collected from a wide range of sources. Upon input of content-identifying information, which is information specifying content, a content-affiliated information acquisition unit (2) acquires content-affiliated information, which is information that is affiliated to the content indicated by the content-identifying information, from sources such as EPG. A content-related text group collection unit (3), based on the content-affiliated information, collects content-related text groups, which are text groups that relate to the content, from text group information sources (1) that store text groups relating to various content, examples of these text group information sources (1) including electronic bulletin boards and home pages connected to the Internet.

### TECHNICAL FIELD

The present invention relates to a content-related information acquisition device, content-related information acquisition method, and content-related information acquisition program for collecting information related to the content or reputation of content such as a broadcast program.

### BACKGROUND ART

When a user searches or selects content that he or she wishes to view from among a vast volume of content such as broadcast programs, information related to this content (hereinbelow referred to as “content-related information”) is used. Content-related information includes descriptions or keywords related to the content of the program such as members of the cast, topics, and objects that appear, or keywords or relevant descriptions such as impressions and reviews of the program such as “entertaining” or “boring.” As methods of acquiring content-related information, many method have been proposed in which content-related information are acquired from the content itself using recognition techniques such as voice recognition, telop recognition, face (personal) recognition, and object recognition.

However, there is a problem in that when content-related information is acquired from the content itself using these recognition techniques, the low level of the performance of the recognition technology not only limits the content-related information that can be acquired but also prevents the acquisition of a wide range of content-related information. More specifically, the use of voice recognition or telop recognition to acquire keywords such as topics or names of the cast can be considered. However, in such cases, although a certain effectiveness can be expected in a news program or in some documentary programs in which the pattern of the telops or the utterances of individuals follow rules or formats to a degree, technological difficulties are encountered in the acquisition of these keywords in, for example, variety programs in which the patterns of subtitles or the utterances of individuals follow no specific formats or rules. In addition, when facial recognition (people) or object recognition is used, data relating to a huge number of faces (people) and objects must be stored in advance in a database, and further, technological difficulties are encountered in referring to this database and accurately specifying these people and objects. An additional problem encountered when using recognition technology to acquire content-related information from content itself is the inability to acquire subjective information such as the reputation, appraisal, feelings, and impressions regarding content.

On the other hand, in program information (hereinbelow referred to as “EPG”) of broadcast programs that is delivered by means of an electronic program guide system, content-related information such as titles, cast, and other details of content are created manually by the content provider. Because EPG is provided before the delivery (broadcast) of the content, it can be used for the search or reservation of a program to be viewed. However, there is the problem that EPG requires the work of hands to create. An additional problem is that, because the provider of content-related information is limited to the provider of the content, content-related information cannot be acquired from a wide range of sources. Still further, there is the problem that the content-related information is often limited to information regarding the title and cast of the content and does not include the description of details regarding the programs. Finally, there is the problem that the content-related information does not include subjective information such as the reputation, appraisal, feelings, and impressions regarding the content.

Systems have been proposed for widely collecting and accumulating information relating to content from users that have actually viewed the content and then providing the content-related information to users. As one example of such a system, a system is described in Patent Document 1 (paragraphs 126-204 and FIG. 1 of JP-A-2002-230039) in which users accumulate content-related information that has been created in correspondence with programs that have been broadcast from a broadcasting station and information for referring to content-related information in a server in correspondence with the programs to provide the content-related information by way of the Internet in correspondence with the program. In Patent Document 1, examples of content-related information and the information for referring to the content-related information include: keywords such as names of people and places; text or html (Hyper Text Markup Language) files that includes content-related information; image data; and URLs (Uniform Resource Locators) of electronic bulletin boards or chat rooms that are operated on the Internet.

In addition, Patent Document 2 (paragraphs 49-157 and FIG. 1 of JP-A-2004-30327) proposes an electronic bulletin board system that aids the creation and sharing of content-related information such as comments relating to each scene in a program. In this electronic bulletin board system, when users write comments, information specifying the programs or scenes relating to the comments are recorded together with the comments.

### DISCLOSURE OF THE INVENTION

However, the problem remains that in order to realize the systems described in Patent Document 1 and Patent Document 2, an interface must be provided to enable users to write, a system must be constructed that is dedicated to collecting and accumulating information that has been written by users, and this system must be operated. The users must then provide content-related information by adding information for specifying, for example, the program or the scenes in accordance with the formats designated by the system, and these requirements place a considerable burden on the users.

It is therefore an object of the present invention to provide a content-related information acquisition device, a content-related information acquisition method, and a content-related information acquisition program that can automatically and widely acquire content-related information from groups of text that have been written freely here and there in already existing outside information sources such as electronic bulletin board systems connected to the Internet without necessitating the construction of a system that uses dedicated user interfaces.

The content-related information acquisition device according to the present invention is provided with: a content-affiliated information acquisition means for, when content-identifying information, which is information that specifies content that includes an image, is supplied as input, acquiring content-affiliated information, which is information belonging to the content that is specified by the content-identifying information; and content-related text group collection means for, based on content-affiliated information, collecting content-related text groups, which are text groups that relate to content that is specified by the content-identifying information, from text group information sources that store text groups relating to a plurality of contents.

The content may be broadcast programs. The content-identifying information may be information indicating either one of content names and delivery information, or information indicating a combination of content names and delivery information.

The content-related text group may include texts relating to the details of the content, or may include texts appraising or giving impressions of the content.

The content-related text collection means may collect content-related text groups from electronic bulletin board systems that are connected to the Internet, these electronic bulletin board systems being the text group information sources. By means of this configuration, content-related text group can be collected from the large number of electronic bulletin board systems that are connected to the Internet.

The content-related text collection means may collect content-related text groups from electronic bulletin board systems, which are text group information sources that store text groups in correspondence with information that identifies the people that wrote the text groups. According to this configuration, the content-related text collection means can collect text that has been written by a specific writer as the content-related text group.

The content-affiliated information may be information that indicates any one of or a combination of a plurality of keywords that represent content name, genre, broadcast channel, delivery channel, broadcast date and time, delivery date and time, or details of the content.

The content-affiliated information acquisition means may acquire index information that has been placed in correspondence with content that is specified by content-identifying information, and may acquire content-affiliated information from the acquired index information. The index information may be program information that is delivered by an electronic program guide system.

The content-affiliated information acquisition means may subject text included in index information to a morpheme analysis to extract keywords as content-affiliated information and thus acquire the content-affiliated information. By means of this configuration, the content-affiliated information can be acquired from index information.

The content-affiliated information acquisition means may acquire content that is specified by the content-identifying information, and recognition results obtained by subjecting the acquired content to a recognition technology may be acquired as content-affiliated information. The content-affiliated information acquisition means may acquire content-affiliated information by applying any one of or a combination of a plurality of technologies among a voice recognition technology, a telop recognition technology, a face recognition technology, a personal recognition technology, or an object recognition technology. By means of this configuration, content-affiliated information can be acquired from contents.

When the content-affiliated information includes any one or more of genre, broadcast channel, delivery channel, and content name, the content-related text group collection means may, based on the content-affiliated information, specify the area in which text groups that are related to content that is specified by content-identifying information are stored in a text group information source that classifies and stores text groups, and then may collect the content-related text groups from the area in the text group information source that has been specified. By means of this configuration, the content-related text group collection means can specify the area in the text group information source in which content-related text group are to be collected.

When the content-affiliated information includes the broadcast date and time or delivery date and time, the content-related text group collection means may refer to the date and time of writing that corresponds to the text group and then collect as content-related text group from the text group information source those text groups for which the date and time of writing is subsequent to the broadcast date and time or delivery date and time. By means of this configuration, the content-related text group collection means can collect as content-related text group from the text group information source those text groups for which the date and time of writing is subsequent to the broadcast date and time or delivery date and time.

When the content-affiliated information includes keywords that indicate details of the content, the content-related text group collection means may collect as content-related text groups text groups that contain the keywords, or text groups that contain the keywords and a prescribed number of text units before and after the text that contain keywords. By means of this configuration, the content-related text group collection means can collect text groups that contain keywords or text groups that contain keywords and the text groups in the vicinities of these text groups.

When the content-affiliated information contains cast names, the content-related text group collection means may collect as content-related text groups those text groups that contain the cast names or text groups that contain the cast names and a prescribed number of text units before and after the text that contains the cast names. By means of this configuration, the content-related text group collection means can collect text groups that contain cast names or text groups that contain cast names and text groups in the vicinities of these text groups.

When there is a plurality of text group information sources, the content-related text group collection means may determine the text group information sources from which content-related text group are to be collected in accordance with the category of content and then collect the content-related text groups from the text group information sources that have been determined. By means of this configuration, the content-related text group collection means can collect content-related text group in accordance with the category of content.

When there is a plurality of text group information sources, the content-related text group collection means may determine the text group information sources from which content-related text groups are to be collected in accordance with genre, broadcast channel, or delivery channel indicated by the content-affiliated information and then collect the content-related text groups from the text group information sources that have been determined. By means of this configuration, the content-related text group collection means can collect content-related text groups in accordance with the content-affiliated information.

When there is a plurality of text group information sources, the content-related text group collection means may determine the text group information sources from which content-related text groups are to be collected in accordance with the purpose of collecting content-related text groups and then collect the content-related text groups from the text group information sources that have been determined.

The content-related text group collection means may generate index information relating to content from content-related text group that have been collected. By means of this configuration, the content-related text group collection means can generate index information from content-related text groups.

The content-related text group collection means may apply collected content-related text groups as input to the content-affiliated information acquisition means. By means of this configuration, the content-related text group collection means can feed back collected content-related text groups to the content-affiliated information acquisition means.

A text analysis means may be provided for analyzing the text of content-related text groups that have been collected by the content-related text group collection means and supplying one or a plurality of content-related keywords. By means of this configuration, one or a plurality of content-related keywords can be supplied as output.

The text analysis means may include a keyword selection means for selecting one or a plurality of content-related keywords from the content-related text groups that have been collected by the content-related text group collection means and supplying as output one or a plurality of content-related keywords that have been selected.

The keyword selection means may separate the text of content-related text groups into morphemes, carry out a morpheme analysis process for conferring part-of-speech information to the separated morphemes, and then select and supply as output content-related keywords from the content-related text groups in accordance with the part-of-speech information that has been conferred to each morpheme. By means of this configuration, content-related keywords can be supplied as output in accordance with part-of-speech information.

The keyword selection means may select and supply morphemes in which the part-of-speech information is noun or proper noun, as the content-related keywords; or may select and supply as the content-related keywords morphemes in which the part-of-speech information is adjective or adverb.

The keyword selection means may include a keyword storage means for storing character strings that are used as content-related keywords, and may select from text of content-related text groups character strings that match with character strings that are stored by the keyword storage means and supply these character strings as content-related keywords.

The text analysis means may include importance determination means for determining the level of importance of each content-related keyword that has been selected by the keyword selection means and then supplying keywords having a high level of importance or supplying keywords in correspondence with the level of importance of each keyword. By means of this configuration, keywords having a high level of importance can be supplied, and keywords can be supplied together with the corresponding level of importance of each keyword.

The importance determination means may determine the level of importance of each of the content-related keywords based on the number of times each of content-related keywords that have been selected by the keyword selection means occurs in the content-related text groups that have been collected by the content-related text group collection means.

The importance determination means may include an importance definition storage means for storing the level of importance of keywords, and may determine the level of importance of content-related keywords based on the level of importance of keywords stored by the importance definition storage means.

The text analysis means may include reputation information aggregation means for extracting content-related keywords that represent appraisal or impressions of the content from among the content-related keywords that have been selected by the keyword selection means, aggregating the number of occurrences of each of the extracted content-related keywords, and supplying the extracted content-related keywords in association with the corresponding number of occurrences. By means of this configuration, the number of occurrences of content-related keywords that represent appraisal or impressions of the content can be supplied.

The text analysis means may include a reputation information aggregation means for extracting content-related keywords that represent appraisal or impressions of content from among content-related keywords that have been selected by the keyword selection means, categorizing the content-related keywords that have been extracted into a plurality of keywords that indicate appraisal ranks that have been defined in advance and aggregating the number of occurrences of each rank, and supplying keywords that indicate the appraisal ranks in association with the corresponding number of occurrences. By means of this configuration, content-related keywords can be categorized into a plurality of appraisal ranks and aggregated.

The text analysis means may generate index information relating to the content from content-related keywords that have been selected. By means of this configuration, index information that relates to the content can be generated from content-related keywords.

The text analysis means may apply the content-related keywords that have been selected to the content-related text group collection means as content-affiliated information. By means of this configuration, content-related keywords can be fed back as content-affiliated information.

A text importance calculation means may be provided for calculating the level of importance of each text of content-related text groups in accordance with conditions under which the content-related text group collection means collected the content-related text groups and applying the calculated level of importance as input to the text analysis means; and the text analysis means may determine the level of importance of content-related keywords that are contained in each text in accordance with the level of importance of each text that has been calculated by the text importance calculation means. By means of this configuration, the level of importance of content-related keywords contained by each text can be determined in accordance with the level of importance of each text.

A user interest information storage means may also be provided for storing user interest information, which is the degree of a user's interest with respect to each keyword; and a content interest calculation means may also be provided for reading from the user interest information storage means the degree of a user's interest with respect to each content-related keyword that is supplied by the text analysis means and, based on the degree of user's interest with respect to each content-related keyword that has been read, calculating the content interest degree, which is the degree of a user's interest with respect to content. By means of this configuration, the degree of content interest can be calculated.

A content presentation means may also be provided for displaying on a display means information indicating content in accordance with the content interest degree that has been calculated by the content interest calculation means.

Content searching means may be provided for, upon input of search conditions of content, extracting content that matches the search conditions based on content-related keywords that have been supplied by the text analysis means; and search result presentation means may be provided for displaying on a display means information indicating the content that has been extracted by the content searching means. By means of this configuration, information indicating the content that matches the search conditions can be displayed on a display means.

The content-related information acquisition method according to the present invention is characterized by, upon input of content-identifying information, which is information for specifying content that includes images, acquiring content-affiliated information, which is information that is affiliated to content that is specified by the content-identifying information, and, based on content-affiliated information, collecting content-related text groups, which are text groups that relate to content specified by content-identifying information, from text group information sources that store text groups that relate to a plurality of items of content.

The content-related information acquisition program according to the present invention causes a computer to execute a content-affiliated information acquisition process for, upon the input of content-identifying information, which is information specifying content that includes images, acquiring content-affiliated information, which is information affiliated to content specified by the content-identifying information; and a content-related text group collection process for, based on content-affiliated information, collecting content-related text groups, which are text groups that relate to content specified by the content-identifying information, from text group information sources that store text groups relating to a plurality of items of content.

According to the present invention, content-related information can be widely and automatically acquired from text groups that have been freely written here and there in already existing outside information sources such as electronic bulletin board systems that are connected to the Internet without constructing a system that uses dedicated user interfaces.

### BRIEF DESCRIPTION OF THE DRAWINGS

FIG. 1 is a block diagram showing a content-related information acquisition device according to the first embodiment of the present invention;

FIG. 2 is an explanatory view showing an example of an EPG;

FIG. 3A is an explanatory view showing an example of narrowing down electronic bulletin boards that collect content-related text groups by means of the titles of the content;

FIG. 3B is an explanatory view showing an example of narrowing down electronic bulletin boards that collect content-related text groups by means of the genre of the content;

FIG. 3C is an explanatory view showing an example of narrowing down electronic bulletin boards that collect content-related text groups by means of the channel by which the content was delivered (broadcast);

FIG. 4 is an explanatory view showing an example of narrowing down text groups to be collected using the date and time that the content was delivered (broadcast);

FIG. 5 is an explanatory view showing an example of narrowing down text groups to be collected using the cast names of the content;

FIG. 6 is an explanatory view showing an example of the narrowing down of text groups to be collected using keywords of the content;

FIG. 7 is an explanatory view showing an example of the addition of content-related text groups to already created EPG;

FIG. 8 is a block diagram showing a content-related information acquisition device according to the second embodiment of the present invention;

FIG. 9 is a block diagram showing an example of the configuration of a text analysis unit;

FIG. 10 is a block diagram showing another example of the configuration of a text analysis unit;

FIG. 11 is a block diagram showing yet another example of the configuration of text analysis unit;

FIG. 12 is an explanatory view showing an example of the addition of content-related keywords to already created EPG;

FIG. 13 is an explanatory view showing an example of the addition to already created EPG of keywords representing appraisal/impressions of content aggregated by a reputation information aggregation unit and the number of occurrences of these keywords;

FIG. 14 is a block diagram showing the content-related information acquisition device according to the third embodiment of the present invention;

FIG. 15 is a block diagram showing the content-related information acquisition device according to the fourth embodiment of the present invention;

FIG. 16 is a block diagram showing a content-related information acquisition device according to the fifth embodiment of the present invention; and

FIG. 17 is a block diagram showing the content-related information acquisition device according to the sixth embodiment of the present invention.

### EXPLANATION OF REFERENCE NUMERALS

1 text group information source
2 content-affiliated information acquisition unit
3 content-related text group collection unit
4 text analysis unit
5 text importance calculation unit
6 content interest calculation unit
7 user interest information storage unit
8 content presentation unit
9 content searching unit
10 search result presentation unit
41 keyword selection unit
42 keyword importance determination unit
43 reputation information aggregation unit

### BEST MODE FOR CARRYING OUT THE INVENTION

### First Embodiment

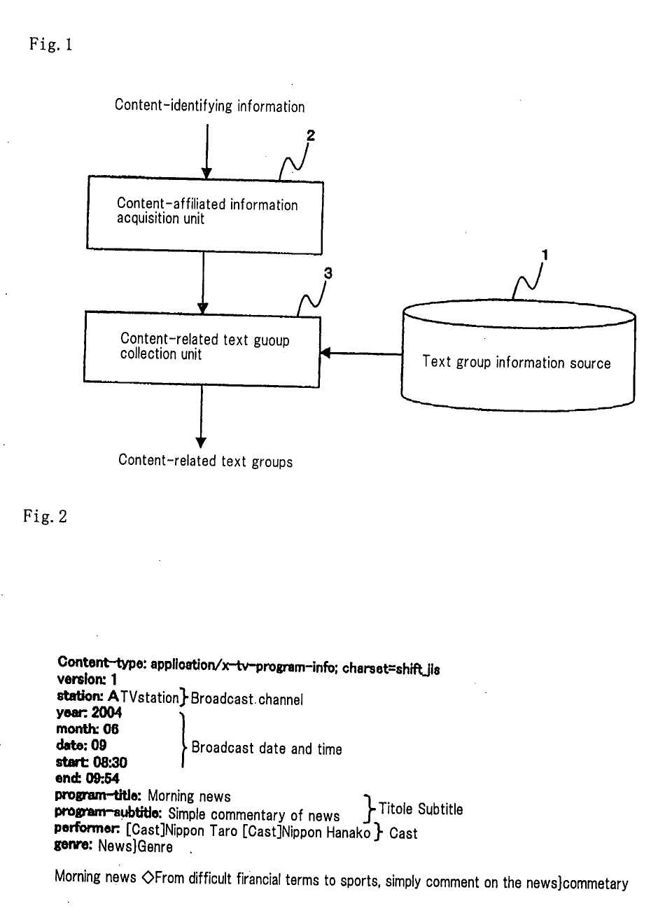

Referring to FIG. 1, the content-related information acquisition device according to the first embodiment of the present invention includes text group information source 1, content-affiliated information acquisition unit 2, and content-related text group collection unit 3.

Upon the input of content-identifying information, which is information specifying content, content-affiliated information acquisition unit 2 acquires content-affiliated information, which is information affiliated with the content indicated by the content-identifying information, and supplies the acquired content-affiliated information to content-related text group collection unit 3.

Based on the content-affiliated information supplied from content-affiliated information acquisition unit 2, content-related text group collection unit 3 collects content-related text groups, which are text groups that relate to the content, from text group information source 1.

The content is information that includes images, and for example, may be a broadcast program (TV program), or may be an aggregate of a plurality of broadcast programs having some form of commonality. Alternatively, the content may be any video content delivered by way of the Internet, or may be the aggregate of a plurality of video content having some form of commonality.

The content-identifying information may be any information that includes information that indicates content. For example, examples of content-identifying information that can be offered include the content name (for example a program title) or delivery information. In this case, the delivery information is information that specifies the delivery medium and delivery time slot of the content, and for example, is information such as the broadcast channel and broadcast time and date for a broadcast program (such as the broadcast starting time and the broadcast ending time).

The content-identifying information may also be information such as keywords that represent details of the content such as the genre, the topics, the cast, and objects. For example, when the content-identifying information includes the information “program title: A” and “broadcast date and time: B,” the content-identifying information indicates the one particular and specific item of content: “program A broadcast on date and at time B.” When the content-identifying information includes the information “broadcast channel: C” and “broadcast date and time: B,” the content-identifying information indicates the one specific item of content “program broadcast on broadcast channel C on date and at time B.” When the content-identifying information includes only the information “program title: A,” the content-identifying information indicates the one specific item of content (program) when the program having the program title “A” is broadcast only at a specific date and time, and indicates the aggregate of a plurality of items of content (programs) “programs A broadcast on all dates and times” when the program having the program title “A” is broadcast at a plurality of dates and times. When the content-identifying information includes the information “broadcast channel: C” and “genre: D,” the content-identifying information indicates the aggregate of a plurality of items of content (programs) “programs belonging to genre D that have been broadcast on broadcast channel C.”

When the content-identifying information indicates one specific item of content, content-related text group collection unit 3 can collect text groups that relate to this one specific item of content, and when the content-identifying information indicates the aggregate of a plurality of items of content, content-related text group collection unit 3 can collect text groups that relate to the total aggregate of the items of content.

Text group information source 1 is an outside information source that holds text groups that relate to various content (for example, including information regarding the details or reputation of various content). One example of text group information source 1 that can be offered is an electronic bulletin board system connected to the Internet. A large number of electronic bulletin board systems are connected to the Internet that take as a topic image content such as various broadcast programs. These electronic bulletin board systems contain abundant written information (text) relating to the details or reputation of the content.

Text group information source 1 may be a WEB page that can be browsed on the Internet and that include articles that review video content (for example, a movie review page); may be an introductory WEB page of video content (for example, the official home page of a broadcast program); or may be any WEB page that is typically widely published on the Internet. Text group information source 1 may further be text groups that are scattered on closed communication networks that are not connected to the Internet; any database that holds text groups (for example, a database that holds surveys written by customers); or mailing lists. Text group information source 1 may also be storage devices in which are stored data such as text, literature, or books. Text group information source 1 may further be one fixed information source, or may be a plurality of information sources. The text groups are composed of text, and the content-related text groups are composed of text relating to the content (for example, including information of the details and reputation of the content).

One method for realizing content-affiliated information acquisition unit 2 that can be offered is a method in which index information is acquired that has been placed in correspondence with content indicated by content-identifying information, following which content-affiliated information is acquired from the acquired index information. In this case, the index information is text that includes information relating to the content such as bibliography information regarding the title of the content, the delivery date and time, the delivery channel, the creator, the date and time of creation, details of the content, the cast, and keywords; or commentaries on the content; and this index information is prepared in advance to correspond with the content. EPG can be offered as an example of index information that has been placed in correspondence with content. When EPG is used, content-affiliated information acquisition unit 2 acquires an EPG that has been placed in correspondence with content that is indicated by content-identifying information from, for example, a server that delivers an electronic program guide or from a database that holds the information of an electronic program guide.

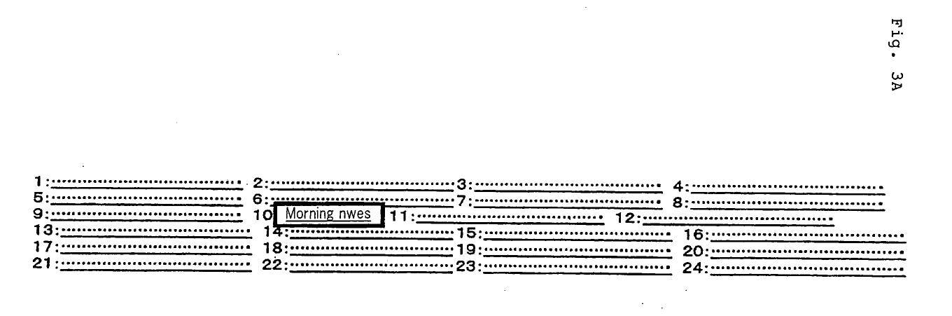

FIG. 2 is an explanatory view showing an example of EPG. When content-affiliated information is acquired from an EPG, content-affiliated information acquisition unit 2 acquires as the content-affiliated information: the title of the content, subtitles, delivery (broadcast) date and time, delivery (broadcast) channel, the genre of the content, the cast, keywords (such as topics or objects) that relate to details of the content that the EPG contains. In addition, content-affiliated information acquisition unit 2 may carry out a morpheme analysis process of the text (for example, a commentary in the EPG) that is included in the index information that has been placed in correspondence with content, and then extract keywords that relate to details of the content as the content-affiliated information (for example, topics or objects) to thus acquire content-affiliated information.

According to another method for realizing content-affiliated information acquisition unit 2, content indicated by content-identifying information is itself acquired, the acquired content is subjected to a recognition technology such as voice recognition, telop recognition, personal recognition realized by face recognition, and object recognition, and the acquired recognition result is acquired as the content-affiliated information. In this case, content-affiliated information acquisition unit 2 acquires the content indicated by the content-identifying information from the storage area in which the content is kept. When the content is subjected to a recognition technology to acquire content-affiliated information, keywords such as topics and the people and objects that appear in the content that are obtained as the recognition results are acquired as the content-affiliated information. One item or a plurality of items of content-affiliated information may be acquired by content-affiliated information acquisition unit 2.

Content-related text group collection unit 3 collects content-related text groups from text group information source 1 based on the content-affiliated information. When there is a plurality of text group information sources 1, all text group information sources 1 may be targets for collection of content-related text groups. Content-related text group collection unit 3 may dynamically determine text group information sources that are to serve as collection targets in accordance with the category of the content and the aim of the collection of content-related text groups and then collect content-related text groups from text group information sources 1 that have been determined as targets for collection.

As an example in which content-related text group collection unit 3 determines text group information sources 1 that are to serve as targets of collection in accordance with the category of the content, when there is a plurality of electronic bulletin board systems (text group information sources 1) that differ according to genre such as a bulletin board dedicated to drama and a bulletin board dedicated to variety programs and the content-affiliated information includes genre information, content-related text group collection unit 3 determines the relevant electronic bulletin board systems as text group information sources 1 that are to serve as targets of collection. Alternatively, when broadcast channels (broadcast stations) provide program WEB pages (text group information sources 1) and the content-affiliated information includes broadcast channel information, content-related text group collection unit 3 may determine the program WEB pages of the relevant broadcast channels as text group information sources 1 that are to serve as the collection targets.

As examples in which content-related text group collection unit 3 determines text group information sources 1 that serve as the targets of collection in accordance with the purpose of collection of content-related text groups, content-related text group collection unit 3 may determine program WEB pages that are connected to the Internet as text group information sources 1 that are the targets of collection when the object is, for example, “to collect information relating to details of the content,” and may determine electronic bulletin board systems that contain an abundance of people's opinions as text group information sources 1 that are the targets of collection when the object is “to collect information relating to the reputation of the content.” This type of method can be realized by maintaining databases in which, for example, categories of content (for example, genre or broadcast channels) or purposes of collection are stored in advance in association with text group information sources 1 that are the targets of collection.

As described in the foregoing explanation, the dynamic switching of text group information sources 1 that are the targets of collection enables collection of content-related text groups in accordance with the category of the content or the purpose of collection.

Content-related text group collection unit 3 may collect content-related text groups by using a keyword search of a typical search engine based on content-affiliated information, or may collect content-related text groups by means of links to text groups that have been manually created beforehand. In addition, when text group information sources 1 categorize and store text groups as: titles, which are content names; delivery (broadcast) channels; genre; and delivery (broadcast) dates and times; content-related text group collection unit 3 may use the titles, delivery (broadcast) channels, genre, delivery (broadcast) dates and times that are included in the content-affiliated information to specify the areas in which text groups that relate to the content that is specified by the content-identifying information are stored within text group information sources 1 in which text groups are categorized and stored and thus collect content-related text groups from the areas in text group information sources 1 that have been specified. For example, when text group information sources 1 are electronic bulletin board systems and these electronic bulletin board systems categorize and record text according to: titles, which are the content names; delivery (broadcast) channels; genre; delivery (broadcast) dates and times; content-related text group collection unit 3 may use the titles, delivery (broadcast) channels, genre, delivery (broadcast) dates and times that are included in content-affiliated information to narrow down the areas (sites) in the electronic bulletin boards systems that collect content-related text groups.

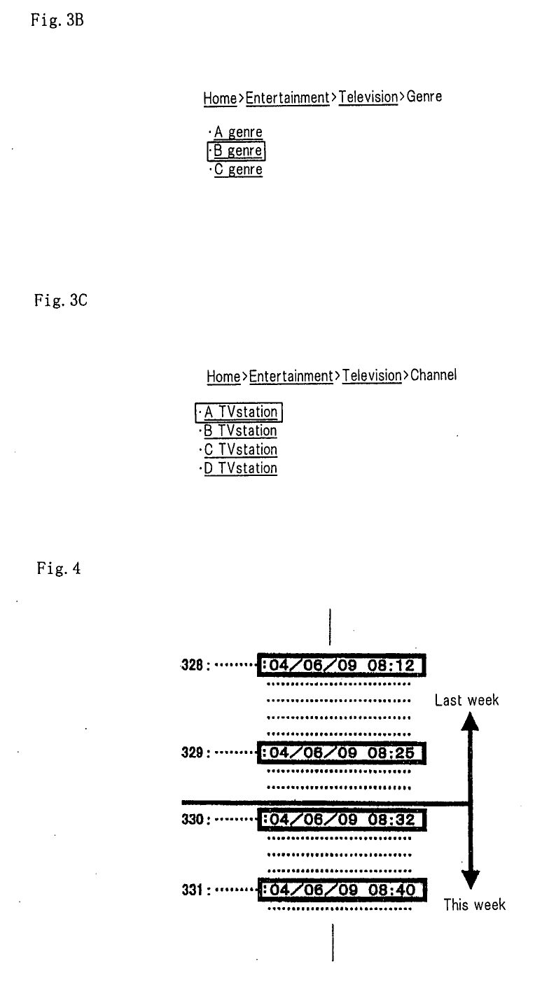

FIGS. 3A-3C are explanatory views showing examples of narrowing down electronic bulletin boards that collect content-related text group according to the title of the content or the delivery (broadcast) channel, and genre.

FIG. 3A shows an example in which text groups are categorized and stored according to the title of the content and the electronic bulletin boards that collect content-related text groups are narrowed down according to the title of the content. This example is a case in which the content-affiliated information includes the information “title: morning news,” and text groups that are to be collected can be narrowed down (specified) to text groups that are categorized and stored as “morning news.”

FIG. 3B shows an example for a case in which text groups are categorized according to the genre of the content, and electronic bulletin boards that collect content-related text groups are narrowed down according to the genre of the content. This example is a case in which the content-affiliated information includes the information “genre: B,” and the text groups that are to be collected can be narrowed down (specified) to text groups that are categorized and stored in “B genre.”

FIG. 3C shows an example for a case in which text groups are categorized and stored according to the channel (station) that has delivered (broadcast) the content, and electronic bulletin boards that collect content-related text groups are narrowed down according to the channel by which the content was delivered (broadcast). This example is a case in which the content-affiliated information includes the information “channel: TV station A,” and the text groups that are to be collected can be narrowed down (specified) to text groups that are categorized and stored in “TV station A.”

When the text groups of electronic bulletin board systems are recorded in association with the date and time of writing, and the content-affiliated information includes information indicating the delivery (broadcast) date and time of the content, the date and time of writing the text may be referred to, sites that relate to the content thus specified, and text groups of the specified sites then collected. For example, the date and time of writing of text may be consulted, and text groups may be collected that have a date that matches the delivery (broadcast) date and time included in the content-affiliated information, or text groups may be collected that have a date and time of writing that is on or after the delivery (broadcast) date and time included in the content-affiliated information. More specifically, when the start date and time of the broadcast (delivery) of the content is June 9, at 8:30 (i.e., when the content-affiliated information includes the information “broadcast start date and time: June 9, 8:30,” text group of June 9 at 8:30 and subsequent times may be specified as the sites that relate to the content, and these text groups may be collected.

FIG. 4 is an explanatory view showing an example in which text groups are placed in correspondence with the date and time of writing and the date and time of delivery (broadcast) of the content is used to narrow down the text groups that are to be collected. In the example shown in FIG. 4, when the starting date and time of delivery (broadcast) of the content is Jun. 9, 2004 at 8:30 a.m. (i.e., when the content-affiliated information includes the information “broadcast start date and time: June 9 at 8:30”), content-related text group collection unit 3 determines that text groups having a date and time that precedes Jun. 9, 2004 at 8:30 a.m. (the text “328” and “329” in FIG. 4) are text for delivery (broadcast) of the preceding week. Content-related text group collection unit 3 then narrows down text groups that should be collected to text groups having a date and time of Jun. 9, 2004 at 8:30 a.m. or later (text “330” and “331” in FIG. 4).

When the content-affiliated information includes the cast of a program or keywords that indicate details of a program, text groups that include these cast member names or keywords or text groups in the vicinities of text groups that contain cast member names or keywords may then be specified as text groups having high relevance to the content and may be collected as content-related text groups. Text groups in the vicinities of text groups that include cast member names or keywords are, for example, a number n items of text groups that precede and follow text groups that include cast member names or keywords. The number n is a prescribed number that is determined in advance by the settings of the content-related information acquisition device or by the user's setting, and may be, for example, “3” or “4.”

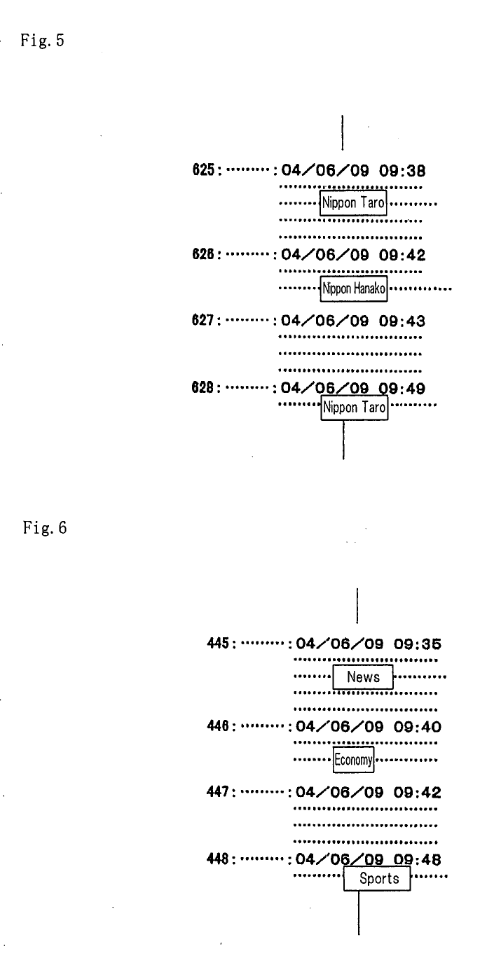

FIG. 5 is an explanatory view showing an example in which the cast member names included in the content-affiliated information are used to narrow down the text groups that should be collected. In the example shown in FIG. 5, a case is shown in which the content-affiliated information includes the information “cast member names: Nippon Taro, Nippon Hanako” and in which content-related text group collection unit 3 narrows down the text groups to be collected to text that contains these cast member names (text “625,” “626,” and “628” in FIG. 5).

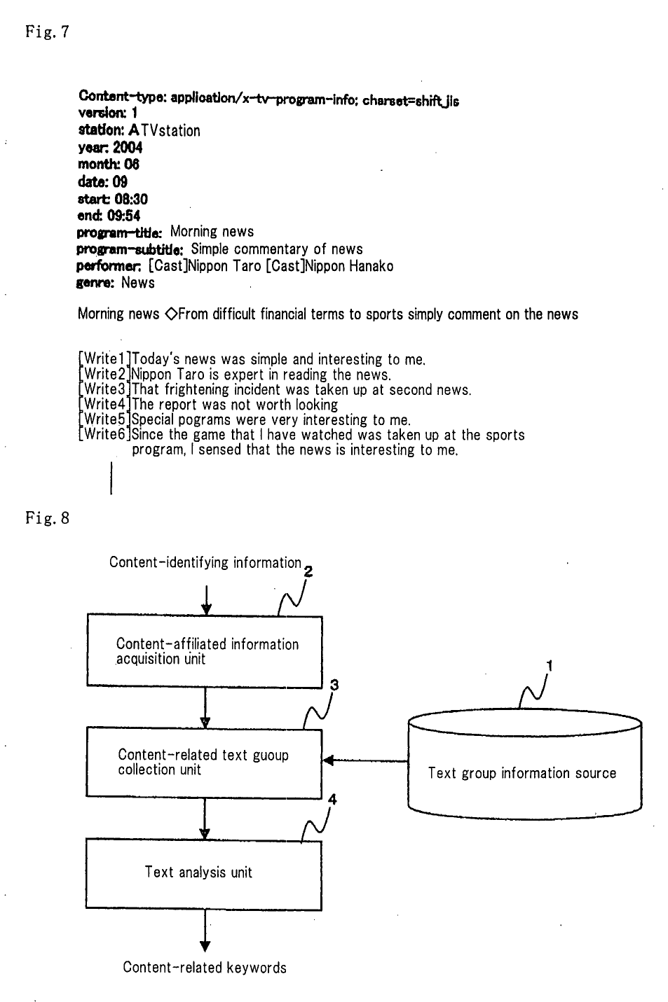

Text groups in the vicinities of text that includes the cast member names may also be collected as content-related text groups. FIG. 6 is an explanatory view showing an example in which keywords of the content are used to narrow down the text groups that should be collected. In the example shown in FIG. 6, the content-affiliated information includes the information “keywords: news, economy, sports” and content-related text group collection unit 3 narrows down the text groups that should be collected to text that includes these keywords (the text “445,” “446” and “448” in FIG. 6).

Text groups in the vicinities of text that contains keywords may also be collected as content-related text groups. Text groups in the vicinities of text that contains keywords are, for example, a number n items of text groups that precede and follow text that contains keywords. The number n is, for example, a prescribed number that is determined in advance by the settings of the content-related information acquisition device or by the settings of the user, and may be, for example, “3” or “4.”

Content-related text group collection unit 3 may also create new index information for the content from the collected content-related text groups. Content-related text group collection unit 3 may also add the collected content-related text groups to already created index information such as EPG.

FIG. 7 is an explanatory view showing an example in which content-related text groups that have been collected are added to already created EPG. In the example shown in FIG. 7, “write 1” to “write 6,” which are content-related text groups that have been collected by content-related text group collection unit 3, are added to already created EPG. In this way, text relating to details of the content or the reputation of the content that have been written by people who have actually viewed the content are reflected in the EPG, and an enriched (having more information) EPG can thus be provided to users when users carry out searching and selection of content.

Content-related text group collection unit 3 may also apply (feed back) content-related text groups that have been collected to content-affiliated information acquisition unit 2. In this case, content-affiliated information acquisition unit 2, for example, subjects newly received content-related text groups to morpheme analysis to extract keywords that relate to details of the content (such as topics or objects) or cast member names as new content-affiliated information, and based on the new content-affiliated information, content-related text group collection unit 3 again collects new content-related text groups. Content-related text groups that have been collected in this way are fed back to content-affiliated information acquisition unit 2, and content-related text group collection unit 3 again carries out the process of collecting content-related text groups to enable the collection of still more content-related text groups. The recursive repetition of this process enables the steady increase of collected content-related text groups.

When the text groups of electronic bulletin board systems are recorded in correspondence with information that identifies the writer and the content-affiliated information includes information that indicates the information that identifies the writer, the information that identifies the writer of the text may be consulted to collect text groups that have been written by a specific writer. More specifically, when an electronic bulletin board system records text written by a Mr. A (i.e., when information indicating that Mr. A is the writer is placed in correspondence with text) and the content-affiliated information includes information that indicates information identifying Mr. A, who is the writer, text that has been written by Mr. A may be collected.

Content-affiliated information acquisition unit 2 and content-related text group collection unit 3 may be realized by, for example, a CPU that operates in accordance with a program. A server that is provided with this type of CPU may be connected to a network that is represented by, for example, the Internet. The program may be recorded on a storage device that is provided in the server. Text group information source 1 is realized by a server that provides electronic bulletin boards or home pages and chat rooms on the Internet.

A content-related information acquisition program is installed in a server that realizes content-affiliated information acquisition unit 2 and content-related text group collection unit 3, whereby, upon the input of content-identifying information, which is information that specifies content that includes images, the program causes a computer to execute: a content-affiliated information acquisition process for acquiring content-affiliated information, which is information that is affiliated with the content that is specified by the content-identifying information; and a content-related text group collection process for, based on the content-affiliated information, collecting content-related text groups, which are text groups that relate to the content specified by the content-identifying information, from text group information sources that store text groups relating to a plurality of items of content.

Explanation next regards the operation of the first embodiment of the present invention. Upon input of content-identifying information to content-affiliated information acquisition unit 2, content-affiliated information acquisition unit 2 acquires content-affiliated information based on the content-identifying information. Content-affiliated information acquisition unit 2 then supplies the content-affiliated information that has been acquired to content-related text group collection unit 3.

Based on the content-affiliated information that has been supplied by content-affiliated information acquisition unit 2, content-related text group collection unit 3 collects content-related text groups from text group information sources 1. Content-related text group collection unit 3 displays the content-related text groups that have been collected on, for example, the display unit (not shown) of a server, and applies the content-related text groups as input to another device. In addition, as a part of the service provided as an ASP (Application Service Provider), the Internet connection provider may also provide the content-related text groups that have been collected by content-related text group collection unit 3 to ASP users.

As described hereinabove, the present embodiment can automatically specify text groups that relate to a particular content and collect content-related text groups from text groups that have been freely written to various sites of text group information sources 1 that are connected to a network such as the Internet without necessitating the construction of a dedicated system in which viewers of content write text.

The present embodiment uses various content-affiliated information to collect content-related text groups, which are text groups that relate to content, and can therefore collect appropriate content-related text groups from a wide range of sources.

### Second Embodiment

Referring now to FIG. 8, the content-related information acquisition device according to the second embodiment of the present invention differs from the first embodiment in that the content-related text groups that have been collected by content-related text group collection unit 3 are applied to text analysis unit 4 for implementing a text analysis. As a result, the same reference numerals as used in FIG. 1 are applied to text group information source 1, content-affiliated information acquisition unit 2, and content-related text group collection unit 3, and redundant explanation of these components is omitted.

Text analysis unit 4 analyzes content-related text groups that have been collected by content-related text group collection unit 3 and supplies content-related keywords, which are keywords that characterize the content. Text analysis unit 4 may supply one or a plurality of content-related keywords.

FIG. 9 is a block diagram showing an example of the configuration of text analysis unit 4.

Text analysis unit 4 includes keyword selection unit 41 that selects keywords that characterize the content from content-related text groups that have been collected by content-related text group collection unit 3 and supplies these keywords as output. Keyword selection unit 41 may select and supply one keyword, or may select and supply a plurality of keywords.

According to one example of a method for realizing the operation of keyword selection unit 41, content-related text groups that are received as input are subjected to a morpheme analysis process (a process of separating text into morphemes, and then conferring part-of-speech information to each separated morpheme), keywords are selected in accordance with the part-of-speech information that has been conferred to each separated morpheme, and the result is supplied as output. As examples keywords selected in accordance with part-of-speech information, nouns or proper nouns may be selected as keywords that represent details of the content (members of the cast, topics, objects that appear, place names, etc.), or adjectives or adverbs may be selected as keywords that represent the reputation or appraisal of the content (such as “entertaining” or “boring”) or keywords that represent impressions of the content (for example, “scary”).

According to another method for realizing the operation of keyword selection unit 41, keyword selection unit 41 includes a keyword dictionary (not shown), which is a keyword storage means (keyword storage device) in which a list of keywords that should be selected is stored in advance, the keyword dictionary is consulted for the content-related text groups that have been received as input, and keywords that are registered in the keyword dictionary are selected and supplied as output. In this case, the keyword dictionary may also store a level of importance corresponding to each keyword.

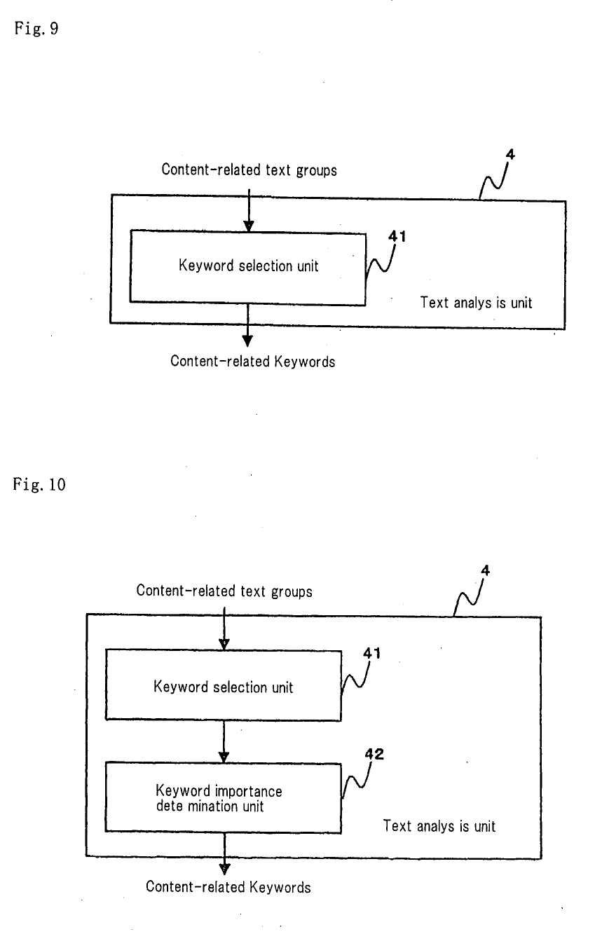

FIG. 10 is a block diagram showing another example of the configuration of text analysis unit 4. In this example of the configuration, keyword importance determination unit (importance determination unit) 42 for determining the level of importance of each keyword selected by keyword selection unit 41 is provided in addition to keyword selection unit 41. Keyword importance determination unit 42 may supply only keywords having a high level of importance according to the level of importance determined for each keyword, or may supply keywords in association with the level of importance that corresponds to each keyword.

According to one an example of a method for realizing the operation of keyword importance determination unit 42, the level of importance is determined according to the frequency of occurrence (number of occurrences) of each keyword in the content-related text groups that have been collected by content-related text group collection unit 3. For example, when the frequency of occurrence of a particular keyword in content-related text groups is high, the importance of that keyword is made high.

According to another method for realizing the operation of keyword importance determination unit 42, an importance definition storage means (not shown) is provided for storing in advance the level of importance of each keyword, and the level of importance of each keyword is then determined according to the level of importance of keywords that are stored in the importance definition storage means. The importance definition storage means stores keywords in association with the level of importance of the keywords. In this case, the level of importance of keywords that are contained in content may be determined by taking into consideration the frequency of occurrence of the keywords in text groups that relate to other content (i.e., content-related text groups of other content). For example, of the keywords that are contained in content, keywords having a high frequency of occurrence in text groups that relate to other content are not keywords that characterize that content, and the level of these keywords is therefore lowered.

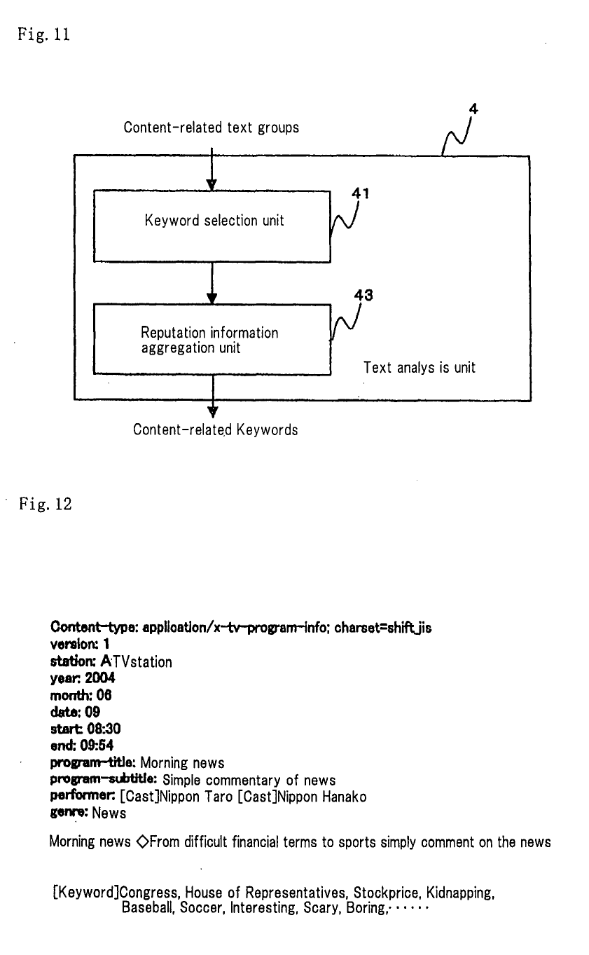

FIG. 11 is a block diagram showing yet another example of the configuration of text analysis unit 4. In this example of the configuration, reputation information aggregation unit 43 is provided in addition to keyword selection unit 41 for aggregating the number of subjective keywords that appraise or give impressions of the content among the keywords that have been selected by keyword selection unit 41.

Reputation information aggregation unit 43 supplies keywords that indicate appraisal or impressions of the content (adjective keywords such as “entertaining,” “boring,” or “scary” and “positive opinions” and “negative opinions”) and the number of these keywords. Keyword selection unit 41 may also select adjective and adverb keywords that represent subjective information such as the appraisal or impressions of the content, and reputation information aggregation unit 43 may extract adjective and adverb keywords that represent subjective information such as appraisal or impressions of the content. In this case, reputation information aggregation unit 43 aggregates the frequency (number) of occurrence of relevant keywords in content-related text groups that have been collected by content-related text group collection unit 3 for each selected keyword that represents appraisal/impressions of content and supplies each keyword in correspondence with the number of occurrences of the keyword. For example, reputation information aggregation unit 43 supplies the aggregate results: “entertaining: 12 occurrences”; “boring: 3 occurrences”; “scary: 1 occurrence.”

Alternatively, reputation information aggregation unit 43 may categorize and aggregate keywords selected by keyword selection unit 41 according to a plurality of keywords that represent ranks of appraisal that have been defined in advance. At this time, reputation information aggregation unit 43 may extract keywords that represent appraisal or impressions of the content among the keywords that have been selected by keyword selection unit 41, categorize the extracted keywords into a plurality of keywords that indicate appraisal ranks that have been defined in advance and aggregate the number of occurrences of each rank, and then supply keywords that indicate the appraisal ranks in correspondence with the number of occurrences of these keywords. For example, when the number of appraisal ranks is “2,” the keywords may be divided between the two keywords “positive opinions” and “negative opinions” and then aggregated. In this case, reputation information aggregation unit 43 includes a category database that categorizes and stores keywords as “positive opinions” and “negative opinions.” For example, the category database registers “entertaining,” “tops,” and “wonderful” as keywords that represent positive opinions and “boring” and “the pits” as keywords that represent negative opinions. Reputation information aggregation unit 43 supplies aggregate results such as “positive opinions: 15 occurrences” and “negative opinions: 6 occurrences.”

Text analysis unit 4 may further create new index information for the content from acquired content-related keywords. Text analysis unit 4 may also add acquired content-related keywords to already created index information such as EPG.

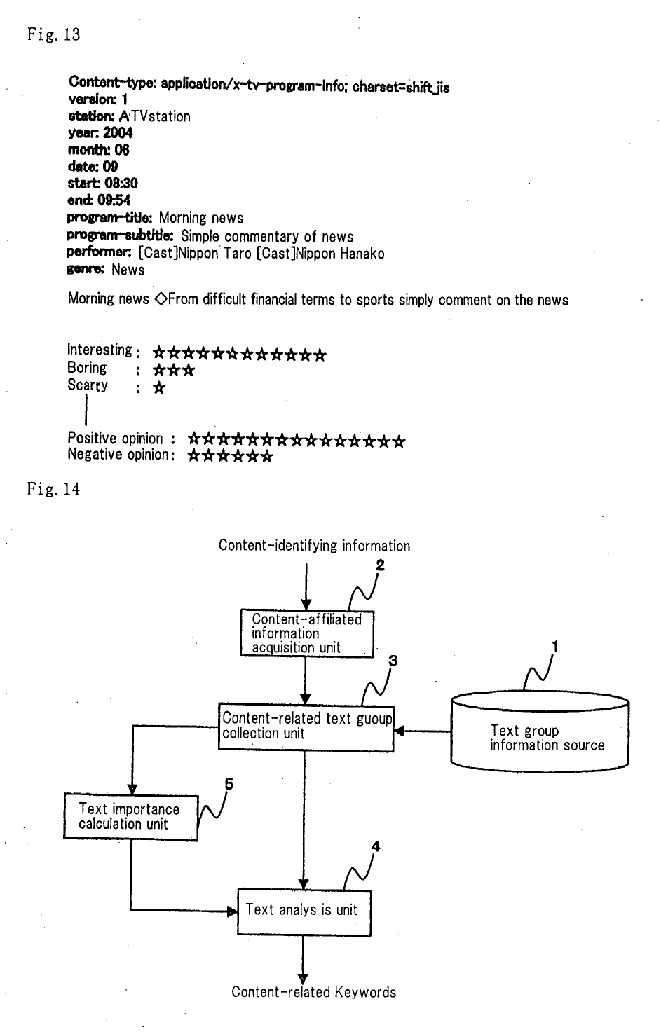

FIG. 12 is an explanatory view showing an example in which content-related keywords are added to already created EPG. In the example shown in FIG. 12, content-related keywords such as “Congress,” “House of Representatives,” “stock prices,” “kidnapping,” “baseball,” “soccer,” “interesting,” “scary,” and “boring” that have been selected by text analysis unit 4 are added to content-related information. FIG. 13 is an explanatory view showing an example in which keywords that represent appraisal/impressions of content that have been aggregated by reputation information aggregation unit 43 along with the number of occurrences of these keywords are added to already created EPG. In the example shown in FIG. 13, the results of categorizing and aggregating keywords representing ranks of appraisal that have been defined in advance as in: “interesting: 12 occurrences,” “boring: 3 occurrences,” “scary: 1 occurrence,” “positive opinion: 15 occurrences,” and “negative opinion: 6 occurrences” are added to already created EPG. In this way, content-related keywords, which are keywords that characterize the content, that have been acquired from text relating to the reputation of the content or details of the content, and that have been written by people who have actually viewed the content are reflected in the EPG, whereby a more enriched EPG can be offered to users in users' search and selection of content.

Text analysis unit 4 may also apply as input (feedback) to content-related text group collection unit 3 acquired content-related keywords as new content-affiliated information. In this case, based on the newly received new content-affiliated information, content-related text group collection unit 3 again collects new content-related text groups. This feedback of the content-related keywords that have been acquired and repeated implementation of the process of collecting content-related text groups enables the collection of a greater abundance of content-related text groups and content-related keywords. The recursive repetition of these processes enables a steady increase of the content-related text groups and content-related keywords that are collected.

The CPU for realizing content-affiliated information acquisition unit 2 and content-related text group collection unit 3 operates based on the content-related information acquisition program in the first embodiment.

Text analysis unit 4 is realized by, for example, a CPU that operates in accordance with a program. This CPU may be identical to the CPU that realizes content-affiliated information acquisition unit 2 and content-related text group collection unit 3.

In addition, content-affiliated information acquisition unit 2 and content-related text group collection unit 3 may be realized by a different server than the server that realizes text analysis unit 4. In this case, the CPU that realizes content-affiliated information acquisition unit 2 and content-related text group collection unit 3 and the CPU that realizes text analysis unit 4 are provided in different servers. In addition, the programs for executing the processes in content-affiliated information acquisition unit 2 and content-related text group collection unit 3 and the program for executing the processes of text analysis unit 4 are each stored in the storage devices of different servers.

As described in the foregoing explanation, collected content-related text groups are subjected to a text analysis and an aggregation process in the present embodiment, whereby keywords can be selected that characterize content and that are effective for searching for content and estimating a user's interests.

### Third Embodiment

Referring to FIG. 14, the content-related information acquisition device according to the third embodiment of the present invention differs from the second embodiment in that content-related text group collection unit 3 applies the collection conditions for each text of the collected content-related text groups to text importance calculation unit 5, which calculates the level of importance of each text (hereinbelow referred to as “text importance”). As a result, the same reference numbers as used in FIG. 8 are applied to text group information source 1, content-affiliated information acquisition unit 2, content-related text group collection unit 3, and text analysis unit 4, and explanation of these components is omitted.

Content-related text group collection unit 3 applies the collection conditions for each text that has been collected to text importance calculation unit 5. The collection conditions for each text that has been collected are the content-affiliated information that is used for specifying the texts that should be collected when collecting text. The collection conditions are, for example, conditions such as: as the content-affiliated information for specifying text, use only the information “content title”; or use the information “content title and broadcast date and time”; or use the information “content title, broadcast date and time, and keywords.”

Text importance calculation unit 5 calculates the level of importance of each text in accordance with the collection conditions for each text that has been received as input from content-related text group collection unit 3. According to one method for calculating the text importance, the text importance is increased as the amount of content-affiliated information that is used as collection conditions increases. For example, the text importance is higher when the information “content title and broadcast date and time” is used as the collection conditions than when only the information “content title” is used as the collection conditions; and the text importance is even higher when the information “content title, broadcast date and time, and keywords” is used as the collection conditions. The calculated text importance for each text is applied as input to text analysis unit 4 in correspondence with the text.

Text analysis unit 4 selects content-related keywords from each text of the content-related text groups that have been collected by content-related text group collection unit 3, implements weighting of the content-related keywords that are included in each text based on the text importance of each text that has been received as input from text importance calculation unit 5, and then aggregates the content-related keywords. The weighting of the content-related keywords is specifically a process by which, for example, text analysis unit 4 raises the level of importance of content-related keywords that are contained in text having high text importance and lowers the level of importance of content-related keywords that are contained in text having low text importance. In accordance with these levels of importance, only keywords having a high level of importance may be supplied, and the levels of importance may also be supplied in correspondence with the keywords. The level of importance of the keywords that are found in this way may also be reflected in the processing of keyword importance determination unit 42 and reputation information aggregation unit 43 that were described in the second embodiment.

The CPU for realizing content-affiliated information acquisition unit 2 and content-related text group collection unit 3 operates based on the content-related information acquisition program in the first embodiment.

Text importance calculation unit 5 is realized by, for example, a CPU that operates according to a program. This CPU may be identical to the CPU that realizes content-affiliated information acquisition unit 2 and content-related text group collection unit 3.

In addition, content-affiliated information acquisition unit 2 and content-related text group collection unit 3 may be realized by a different server than the server that realizes text analysis unit 4 and text importance calculation unit 5. In such a case, the CPU that realizes content-affiliated information acquisition unit 2 and content-related text group collection unit 3 and the CPU that realizes text analysis unit 4 and text importance calculation unit 5 are provided in different servers. In addition, the programs for causing content-affiliated information acquisition unit 2 and content-related text group collection unit 3 to execute processing and the programs for causing text analysis unit 4 and text importance calculation unit 5 to execute processing are stored in the storage devices of different servers.

As described in the foregoing explanation, according to the present embodiment, the level of importance of texts is calculated according to the collection conditions of content-related keywords and the aggregation of content-related keywords is carried out based on the calculated level of importance of text, and as a result, content-related keywords can be obtained in which the information of texts that are believed to have greater relation to content are more strongly reflected.

### Fourth Embodiment

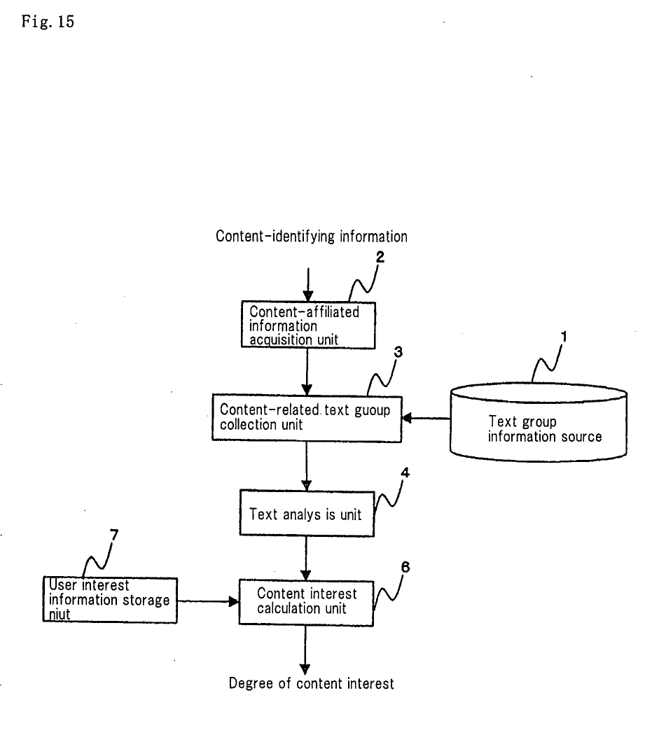

Referring to FIG. 15, the content-related information acquisition device according to the fourth embodiment of the present invention differs from the second embodiment in that text analysis unit 4 applies content-related keywords as input to content interest calculation unit 6, which calculates the degree of a user's interest in the content, and content interest calculation unit 6 reads, from user interest information storage unit 7 that stores the degree of a user's interest with respect to keywords, the degree of interest for content-related keywords. As a result, the same reference numbers as used in FIG. 8 are used for text group information source 1, content-affiliated information acquisition unit 2, content-related text group collection unit 3, and text analysis unit 4, and explanation of these components is omitted.

User interest information storage unit 7 stores user interest information in advance, this user interest information being information regarding the degree of a user's interest with respect to keywords. When text analysis unit 4 applies content-related keywords as input to content interest calculation unit 6, content interest calculation unit 6 reads from user interest information storage unit 7 the user interest information for the content-related keywords that text analysis unit 4 applied as input and calculates the content interest level, which is the degree of a user's interest in the content. As the user interest information, for example, the degree of user's interest in keywords may be converted to a numerical value and then stored.

According to one example of a method of calculating the content interest level by means of content interest calculation unit 6, if the user interest information of user A is assumed to be, for example, the information “news: 0.9; economy: 0.7; Congress: 0.8; sports: 0.1; soccer: 0.2; baseball: 0.3; and so on,” the content interest level of user A for content B is calculated as: “0.9+0.7+0.8=2.4” if the content-related keywords of content B are “news, economy, Congress,” and the content interest level of user A for content C is calculated as: “0.1+0.2+0.3=0.6” if the content-related keywords of content C are “sports, soccer, baseball.”

If this embodiment is combined with the third embodiment, text importance calculation unit 5 may calculate the level of importance of each text of content-related text collected by content-related text group collection unit 3 and then apply the calculated level of importance as input to text analysis unit 4.

The user interest information stored by user interest information storage unit 7 is not limited to the information of a user's interest level for keywords of one particular individual, and may be information regarding the level of interest for keywords of a particular model (for example, the preferred content is variety programs) or a particular group (for example, men in their 20s). Then, when the user applies information specifying a model or group that is close to his or her own attributes as input to content interest calculation unit 6, content interest calculation unit 6 calculates the content interest level of this model or group and automatically records content that accords with the interest of this model or group on an image recording device.

The CPU that realizes content-affiliated information acquisition unit 2 and content-related text group collection unit 3 operates based on the content-related information acquisition program in the first embodiment.

Content interest calculation unit 6 is realized by, for example, a CPU that operates according to a program. This CPU may be identical to the CPU that realizes content-affiliated information acquisition unit 2 and content-related text group collection unit 3.

In addition, the server that realizes content-affiliated information acquisition unit 2 and content-related text group collection unit 3, the server that realizes text analysis unit 4 and text importance calculation unit 5, and the server that realizes content interest calculation unit 6 and user interest information storage unit 7 may all be different servers. In such a case, the CPU that realizes content-affiliated information acquisition unit 2 and content-related text group collection unit 3, the CPU that realizes text analysis unit 4 and text importance calculation unit 5, and the CPU that realizes content interest calculation unit 6 are each provided in separate servers. The program for causing content-affiliated information acquisition unit 2 and content-related text group collection unit 3 to execute processing, the program for causing text analysis unit 4 and text importance calculation unit 5 to execute processing, and the program for causing content interest calculation unit 6 to execute processing may each be stored in the storage device of a different server.

As described in the foregoing explanation, the present embodiment enables the calculation of content interest level, which is a user's level of interest in content, and as a result, when the content interest level and content-identifying information are applied as input in advance to an image-recording device, content according to the user's interests can be automatically recorded.

In addition, the user interest information of an individual may be generated based on a series of texts (writings) that have been written by that person to an electronic bulletin board of text group information source 1 in advance, and the generated user interest information may be used to calculate the content interest level. By taking this approach, a user having content interest levels that resemble those of a person who has written to the electronic bulletin board of text group information sources 1 can automatically record content to an image recording device according to the content interest level of the person who has written to the electronic bulletin board of text group information sources 1.

### Fifth Embodiment

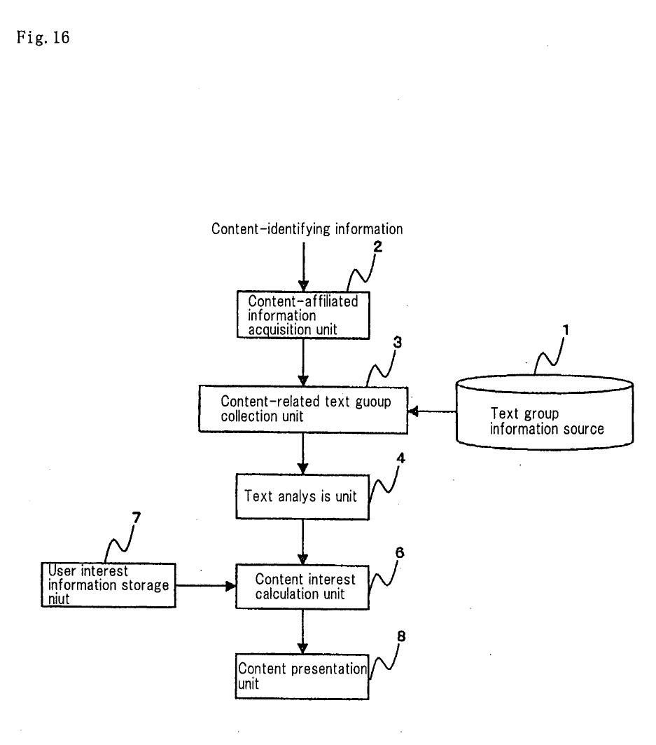

Referring to FIG. 16, the content-related information acquisition device according to the fifth embodiment of the present invention differs from the fourth embodiment in that content interest calculation unit 6 applies content interest levels to content presentation unit 8 that presents content titles according to the content interest level. As a result, the same reference numbers as in FIG. 15 are applied to text group information source 1, content-affiliated information acquisition unit 2, content-related text group collection unit 3, text analysis unit 4, content interest calculation unit 6, and user interest information storage unit 7, and explanation of these components is omitted.

When the content-identifying information of a plurality of items of content is applied as input to content-affiliated information acquisition unit 2, content-affiliated information acquisition unit 2 acquires content-affiliated information for each of the plurality of items of content-identifying information and applies this content-affiliated information as input to content-related text group collection unit 3 in correspondence with the content-identifying information. Content-related text group collection unit 3 collects content-related text groups from text group information source 1 based on the content-affiliated information and applies these text groups to text analysis unit 4 in correspondence with the content-identifying information. Text analysis unit 4 selects content-related keywords from the content-related text groups and applies these keywords to content interest calculation unit 6 in correspondence with the content-identifying information. Content interest calculation unit 6 calculates the content interest level based on the content interest information that has been stored by user interest information storage unit 7 and applies this content interest level as input to content presentation unit 8 in correspondence with the content-identifying information. Content presentation unit 8 extracts information such as title names of content from the content-identifying information and then displays on a display means the title name of the content for which the content interest level is high, or displays on the display means the title names of content in the order of higher content interest levels.

This embodiment may be combined with the configuration of the third embodiment such that text importance calculation unit 5 calculates the level of importance of each text of the content-related text that has been collected by content-related text group collection unit 3 and supplies the calculated level of importance as input to text analysis unit 4.

The CPU for realizing content-affiliated information acquisition unit 2 and content-related text group collection unit 3 operates based on the content-related information acquisition program in the first embodiment.

Content presentation unit 8 may be realized by, for example, a CPU that operates in accordance with a program. This CPU may be identical to the CPU that realizes content-affiliated information acquisition unit 2 and content-related text group collection unit 3.

The server for realizing content-affiliated information acquisition unit 2 and content-related text group collection unit 3, the server for realizing text analysis unit 4 and text importance calculation unit 5, and the server for realizing content interest calculation unit 6, user interest information storage unit 7, and content presentation unit 8 may all be different servers. In such a case, the CPU for realizing content-affiliated information acquisition unit 2 and content-related text group collection unit 3, the CPU for realizing text analysis unit 4 and text importance calculation unit 5, and the CPU for realizing content interest calculation unit 6 and content presentation unit 8 are each provided in different servers. The program for causing content-affiliated information acquisition unit 2 and content-related text group collection unit 3 to execute processing, the program for causing text analysis unit 4 and text importance calculation unit 5 to execute processing, and the program for causing content interest calculation unit 6 and content presentation unit 8 to execute processing are each stored in the storage device of different servers.

As described in the foregoing explanation, according to the present embodiment, title names of content for which the content interest level is high are displayed on a display means or title names of contents are displayed in the order of higher content interest levels, whereby the viewing or recording of content can be recommended to the user.

### Sixth Embodiment

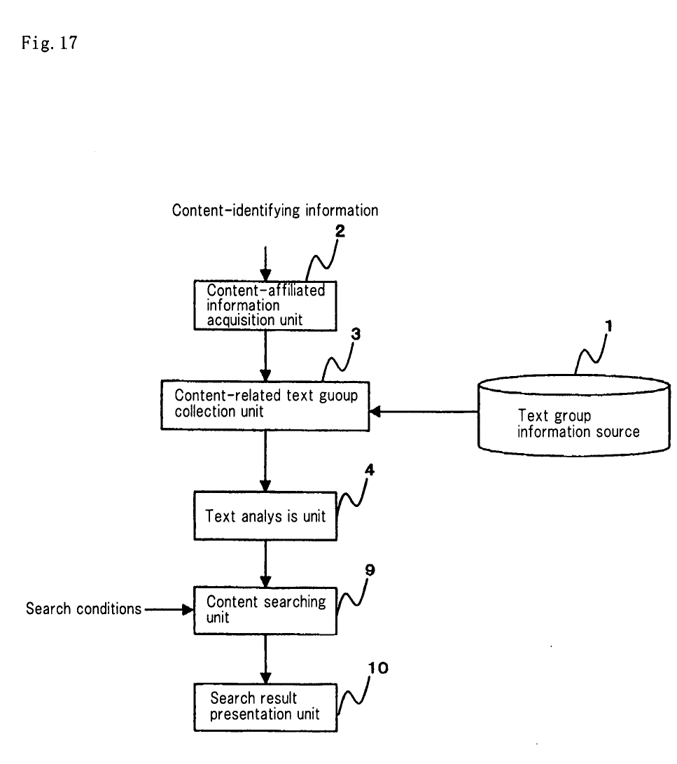

Referring to FIG. 17, the content-related information acquisition device according to the sixth embodiment of the present invention differs from the fourth embodiment in that text analysis unit 4 applies content-related keywords as input to content searching unit 9, which searches for content using content-related keywords based on the search conditions of content that have been applied as input by a user, and content searching unit 9 applies the results of searching to search result presentation unit 10, which presents the results of searching by content searching unit 9. As a result, the same reference numbers that were used in FIG. 15 are applied to text group information source 1, content-affiliated information acquisition unit 2, content-related text group collection unit 3, and text analysis unit 4, and explanation of these components is omitted.

When the content-identifying information of a plurality of items of content is applied as input to content-affiliated information acquisition unit 2, content-affiliated information acquisition unit 2 acquires content-affiliated information for each of the plurality of items of content-identifying information and applies the acquired content-affiliated information in correspondence with the content-identifying information to content-related text group collection unit 3. Content-related text group collection unit 3 collects content-related text groups based on the content-affiliated information from text group information sources 1 and applies the content-related text groups in correspondence with the content-identifying information to text analysis unit 4. Text analysis unit 4 selects content-related keywords from the content-related text groups and applies the content-related keywords in correspondence with the content-identifying information as input to content searching unit 9. Content searching unit 9, upon receiving the search conditions of the content from the user, searches the content-identifying information that corresponds to the content-related keywords to extract content-identifying information that matches with the search conditions of content that have been applied as input by the user. In this case, the content search conditions are, for example, keywords of the content. Content searching unit 9 applies the extracted content-identifying information as input to search result presentation unit 10. Search result presentation unit 10 extracts, for example, title names of content from the content-identifying information and displays the title names of content on a display means.

The present embodiment may be combined with the third embodiment, whereby text importance calculation unit 5 calculates the level of importance of each text of the content-related text that has been collected by content-related text group collection unit 3 and applies the calculated level of importance to text analysis unit 4.

The CPU for realizing content-affiliated information acquisition unit 2 and content-related text group collection unit 3 operates based on the content-related information acquisition program in the first embodiment.

Content searching unit 9 and search result presentation unit 10 are realized, for example, by a CPU that operates according to a program. This CPU may be identical to the CPU for realizing content-affiliated information acquisition unit 2 and content-related text group collection unit 3.

In addition, the server for realizing content-affiliated information acquisition unit 2 and content-related text group collection unit 3, the server for realizing text analysis unit 4 and text importance calculation unit 5, and the server for realizing content searching unit 9 and search result presentation unit 10 may each be different servers. In such a case, the CPU for realizing content-affiliated information acquisition unit 2 and content-related text group collection unit 3, the CPU for realizing text analysis unit 4 and text importance calculation unit 5, and the CPU for realizing content searching unit 9 and search result presentation unit 10 are each provided in different servers. Still further, the program for causing content-affiliated information acquisition unit 2 and content-related text group collection unit 3 to execute processing, the program for causing text analysis unit 4 and text importance calculation unit 5 to execute processing, and the program for causing content searching unit 9 and search result presentation unit 10 to execute processing are each stored in the storage devices of different servers.

As described in the foregoing explanation, according to the present embodiment, information such as title names of content that matches the search conditions that have been applied as input by a user are displayed on a display means, whereby the user is able to carry out a search for content.

### POTENTIAL FOR UTILIZATION IN INDUSTRY

The present invention can be used in the collection of information that relates to content that contains images and in searching for content.

1. A content-related information acquisition device comprising:
a content-affiliated information acquisition means for, when content-identifying information, which is information that specifies content that includes an image, is supplied as input, acquiring content-affiliated information, which is information belonging to said content that is specified by said content-identifying information; and
a content-related text group collection means for, based on said content-affiliated information, collecting content-related text groups, which are text groups that relate to said content that is specified by said content-identifying information, from text group information sources that store text groups relating to a plurality of items of said content.

2. A content-related information acquisition device according to claim 1, wherein said content is a broadcast program.

3. A content-related information acquisition device according to claim 1 or claim 2, wherein said content-identifying information is information indicating either one of content names and delivery information, or information indicating a combination of content names and delivery information.

4. A content-related information acquisition device according to any one of claims 1 to 3, wherein said content-related text groups include texts relating to the details of content.

5. A content-related information acquisition device according to any one of claims 1 to 4, wherein said content-related text groups contain texts of appraisal or impressions of content.

6. A content-related information acquisition device according to any one of claims 1 to 5, wherein said content-related text collection means collects content-related text groups from electronic bulletin board systems that are connected to the Internet, these electronic bulletin board systems being said text group information sources.

7. A content-related information acquisition device according to claim 6, wherein said content-related text collection means collects content-related text groups from electronic bulletin board systems, which are text group information sources that store text groups in correspondence with information that identifies the people that wrote the text groups.

8. A content-related information acquisition device according to any one of claims 1 to 7, wherein said content-affiliated information is information that indicates any one of, or a combination of a plurality of keywords that represent content name, genre, broadcast channel, delivery channel, broadcast date and time, delivery date and time, and details of the content.

9. A content-related information acquisition device according to any one of claims 1 to 8, wherein said content-affiliated information acquisition means acquires index information that has been placed in correspondence with content that is specified by content-identifying information, and acquires content-affiliated information from said acquired index information.

10. A content-related information acquisition device according to claim 9, wherein said index information is program information that is delivered by an electronic program guide system.

11. A content-related information acquisition device according to claim 9 or claim 10, wherein said content-affiliated information acquisition means subjects text included in index information to a morpheme analysis to extract keywords as content-affiliated information, and thus acquires said content-affiliated information.

12. A content-related information acquisition device according to any one of claims 1 to 11, wherein said content-affiliated information acquisition means acquires content specified by content-identifying information, and recognition results obtained by subjecting said acquired content to a recognition technology is acquired as content-affiliated information.

13. A content-related information acquisition device according to claim 12, wherein said content-affiliated information acquisition means acquires content-affiliated information by applying any one of or a combination of a plurality of technologies among a voice recognition technology, a subtitle (telop) recognition technology, a face recognition technology, a personal recognition technology, or an object recognition technology.

14. A content-related information acquisition device according to any one of claims 1 to 13, wherein, when said content-affiliated information includes any one or more of genre, broadcast channel, delivery channel, and content name, said content-related text group collection means, based on said content-affiliated information, specifies the area in which text groups that are related to content that is specified by content-identifying information are stored in a text group information source that classifies and stores text groups, and then collects content-related text groups from the area in the text group information source that has been specified.

15. A content-related information acquisition device according to any one of claims 1 to 14, wherein, when said content-affiliated information includes the broadcast date and time or delivery date and time, said content-related text group collection means refers to the date and time of writing that corresponds to the text group and then collect as content-related text group from the text group information sources said text groups for which the date and time of writing is subsequent to said broadcast date and time or delivery date and time.

16. A content-related information acquisition device according to any one of claims 1 to 15, wherein, when said content-affiliated information includes keywords that indicate details of the content, said content-related text group collection means collects as content-related text groups text groups that contain said keywords, or text groups that contain said keywords and a prescribed number of text units before and after text that contains said keywords.

17. A content-related information acquisition device according to any one of claims 1 to 16, wherein, when said content-affiliated information contains cast names, said content-related text group collection means collects as content-related text groups text groups that contain said cast names or text groups that contain said cast names and a prescribed number of text units before and after text that contains said cast names.

18. A content-related information acquisition device according to any one of claims 1 to 17, wherein, when there is a plurality of said text group information sources, said content-related text group collection means determines said text group information sources from which content-related text group are to be collected in accordance with the category of content and collects said content-related text groups from said text group information sources that have been determined.

19. A content-related information acquisition device according to any one of claims 1 to 18, wherein, when there is a plurality of text group information sources, said content-related text group collection means determines the text group information source from which content-related text groups are to be collected in accordance with genre, broadcast channel, or delivery channel indicated by said content-affiliated information and then collects said content-related text groups from said text group information sources that have been determined.

20. A content-related information acquisition device according to any one of claims 1 to 19, wherein, when there is a plurality of text group information sources, said content-related text group collection means determines text group information sources from which content-related text groups are to be collected in accordance with the purpose of collecting content-related text groups and then collects said content-related text groups from said text group information sources that have been determined.

21. (canceled)

22. A content-related information acquisition device according to any one of claims 1 to 21, wherein said content-related text group collection means applies content-related text groups that have been collected as input to the content-affiliated information acquisition means.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A content-related information acquisition device according to any one of claims 1 to 21, further comprising:
a text importance calculation means for calculating the level of importance of each text of said content-related text groups in accordance with conditions under which said content-related text group collection means collected the content-related text groups; and
a text analysis means for determining the level of importance of content-related keywords contained in each said text in accordance with the level of importance of each said text calculated by said text importance calculation means.

37. (canceled)

38. (canceled)

39. (canceled)

40. A content-related information acquisition method comprising the steps of:
upon input of content-identifying information, which is information for specifying content that includes images, acquiring content-affiliated information, which is information that is affiliated to said content that is specified by said content-identifying information, and
based on said content-affiliated information, collecting content-related text groups, which are text groups that relate to said content specified by said content-identifying information, from text group information sources that store text groups that relate to a plurality of items of said content.

41. A content-related information acquisition program for causing a computer to execute:
a content-affiliated information acquisition process for, upon input of content-identifying information, which is information specifying content that includes images, acquiring content-affiliated information, which is information affiliated to said content specified by said content-identifying information; and
a content-related text group collection process for, based on said content-affiliated information, collecting content-related text groups, which are text groups that relate to said content specified by said content-identifying information, from text group information sources that store text groups relating to a plurality of items of said content.

42. A content-related information acquisition device comprising:
content-affiliated information acquisition means for: upon input of content-identifying information, which is information specifying a broadcast program, acquiring program information that is delivered by an electronic program guide system that corresponds to said broadcast program specified by said content-identifying information; and acquiring, from said acquired program information, content-affiliated information, which is information affiliated with said broadcast program specified by said content-identifying information; and
content-related text group collection means for, based on said content-affiliated information, collecting content-related text groups, which are text groups that relate to said broadcast program specified by said content-identifying information from an electronic bulletin board system connected to the Internet for storing text groups that relate to a plurality of broadcast programs.
